(19) United States
(12) Patent Application Publication
(10) Pub. No.: US 2017/0085656 A1
(43) Pub. Date: Mar. 23, 2017

(54) AUTOMATIC ABSOLUTE ORIENTATION AND POSITION

(71) Applicant: Nvidia Corporation, Santa Clara, CA (US)

(72) Inventors: Joshua ABBOTT, Raleigh, NC (US); James van WELZEN, Durham, NC (US); Alejandro TROCCOLI, Santa Clara, CA (US); Asad Ullah NAWEED, Carrboro, NC (US)

(21) Appl. No.: 14/861,988

(22) Filed: Sep. 22, 2015

(51) Int. Cl. H04L 29/08; G06T 19/00; H04W 4/02

(52) U.S. Cl. CPC H04L 67/18; H04W 4/02; G06T 19/006

(57) ABSTRACT

Methods of determining an absolute orientation and position of a mobile computing device are described for use in augmented reality applications, for instance. In one approach, the framework implemented herein detects known objects within a frame of a video feed. The video feed is captured in real time from a camera connected to a mobile computing device such as a smartphone or tablet computer, and location coordinates are associated with one or more known objects detected in the video feed. Based on the location coordinates of the known objects within the video frame, the user's position and orientation is triangulated with a high degree of precision.

### CROSS-REFERENCE TO RELATED APPLICATIONS

This patent application is related to and incorporates by reference herein in their entirety, the following patent application that is co-owned and concurrently filed herewith:
(1) U.S. patent application Ser. No. ______, entitled Automatic “Absolute Orientation and Position Calibration” by Abbott et al., Attorney Docket No. NVID-PDU-130525US01.

### FIELD

Embodiments of the present invention generally relate to the field of augmented reality. More specifically, embodiments of the present invention relate to systems and methods for determining orientation and position for augmented reality content.

### BACKGROUND

There is a growing need, in the field of Augmented Reality, to track the location and orientation of a device with a high degree of precision. GPS systems typically used in small-scale systems tend to offer only a limited degree of precision and are not generally useable for real-time Augmented Reality applications. While processes for smoothing the raw output of GPS systems using specialized software may improve these GPS systems in some situations, the results are still not accurate enough to support many Augmented Reality applications, particularly in real-time.

Augmented Reality applications typically supplement live video with computer-generated sensory input such as sound, video, graphics or GPS data. It is necessary to keep track of both the position and orientation of a device during an Augmented Reality session to accurately represent the position of known objects and locations within the Augmented Reality application.

Unfortunately, modern GPS systems offer only a limited degree of accuracy when implemented in small-scale systems. For example, a user may travel several feet before the movement is recognized by the GPS system and then the content of the Augmented Reality application is updated to reflect the new location and position. In some scenarios, the GPS system may depict the user rapidly jumping between two or more positions when the user is actually stationary. Furthermore, some sensors common in conventional mobile devices (e.g., magnetometers) are susceptible to drift when tracking a device's orientation, thereby rendering them unreliable unless the drift is detected and compensated for.

The limited accuracy of these GPS systems and sensors makes them difficult to use effectively in Augmented Reality applications, where a low level of precision is detrimental to the overall user experience. Thus, what is needed is a device capable of determining and tracking absolute position and orientation of a small-scale device with a high degree of accuracy and precision.

### SUMMARY

A method of determining the absolute position and orientation of a mobile computing device is disclosed herein. The method includes capturing a live video feed on the mobile computing device. A first object, a second object, and a third object are detected in one or more frames of the live video feed, where the first object is associated with a first set of location coordinates, the second object is associated with a second set of location coordinates, and the third object is associated with a third set of location coordinates and is non-collinear with respect to the first and second objects. The absolute position and orientation of the mobile computing device are determined based on the set of location coordinates associated with the first, second, and third objects.

More specifically, a computer usable medium is disclosed having computer-readable program code embodied therein for causing a mobile computer system to execute method of determining the absolute position and orientation of the mobile computing device. The method captures a live video feed on the mobile computing device. First, second, and third objects are detected in one or more frames of the live video feed, where the first object is associated with a first set of location coordinates, the second object is associated with a second set of location coordinates, and the third object is associated with a third set of location coordinates and is non-collinear with respect to the first and second objects. The absolute position and orientation of the mobile computing device are automatically determined based on the set of location coordinates associated with the first, second, and third objects.

A mobile computing device is also disclosed. The device includes a display screen, a general purpose processor, a system memory, and a camera configured to capture a live video feed and store the video feed in the system memory e.g., using a bus. The general purpose processor is configured to analyze the live video feed to locate first, second, and third objects in one or more frames of the live video feed. The first object is associated with a first set of location coordinates, the second object is associated with a second set of location coordinates, the third object is associated with a third set of location coordinates and is non-collinear with respect to the first and second objects, and the general purpose processor is further configured to compute an absolute position and orientation of the mobile computing device based on the set of location coordinates associated with the first, second, and third objects.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system upon which embodiments of the present invention may be implemented.

FIG. 2 is a diagram representing a user's position in relation to three exemplary known objects according to embodiments of the present invention.

FIG. 3 is an illustration of an exemplary mobile computing device and interface for determining a position of a first object according to embodiments of the present invention.

FIG. 4 is an illustration of an exemplary mobile computing device and interface for determining a position of a second object according to embodiments of the present invention.

FIG. 5 is an illustration of an exemplary mobile computing device and interface for determining a position of a third object according to embodiments of the present invention.

FIG. 6 is an illustration of an exemplary mobile computing device and interface for observing live video with an augmented reality overlay according to embodiments of the present invention.

FIG. 7 is a flowchart depicting an exemplary sequence of computer implemented steps for detecting a known object in a video feed according to embodiments of the present invention.

FIG. 8 is a flowchart depicting an exemplary sequence of computer implemented steps for determining an absolute position and orientation of a mobile computing device according to embodiments of the present invention.

FIG. 9 illustrates an exemplary process for calculating a position of a fourth point, given three points of known position that form a triangle according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

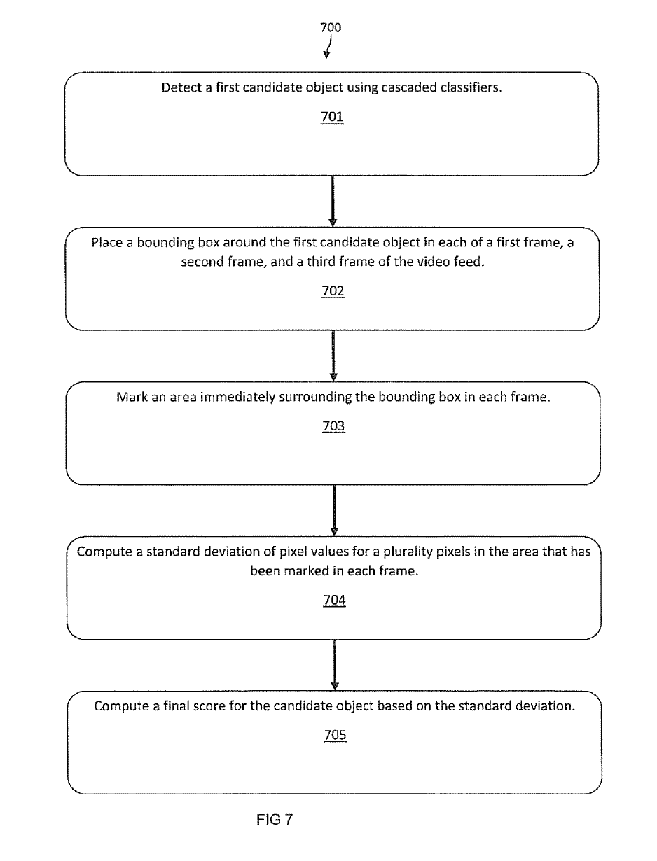

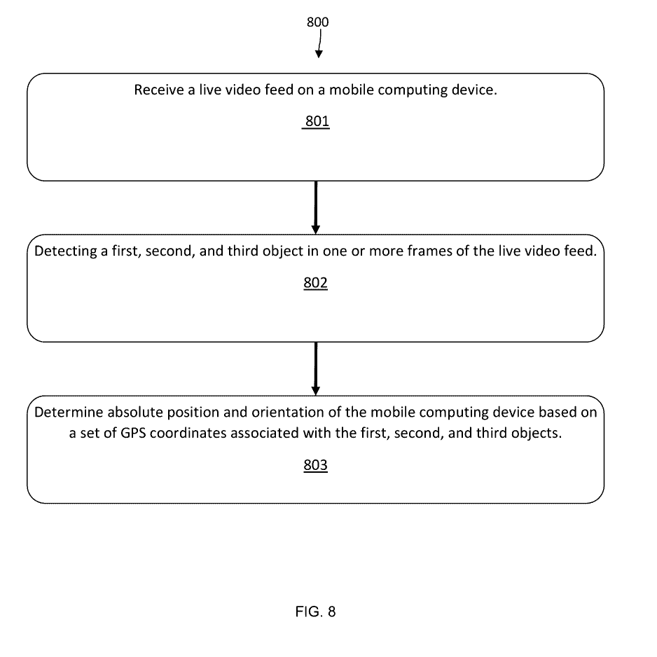

Portions of the detailed description that follows are presented and discussed in terms of a method. Although steps and sequencing thereof are disclosed in a figure herein (e.g., FIGS. 7 and 8) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Exemplary Mobile Computing Device with Touch Screen

Embodiments of the present invention are drawn to mobile computing devices having at least one camera system and a touch sensitive screen or panel. The following discussion describes one such exemplary mobile computing device.

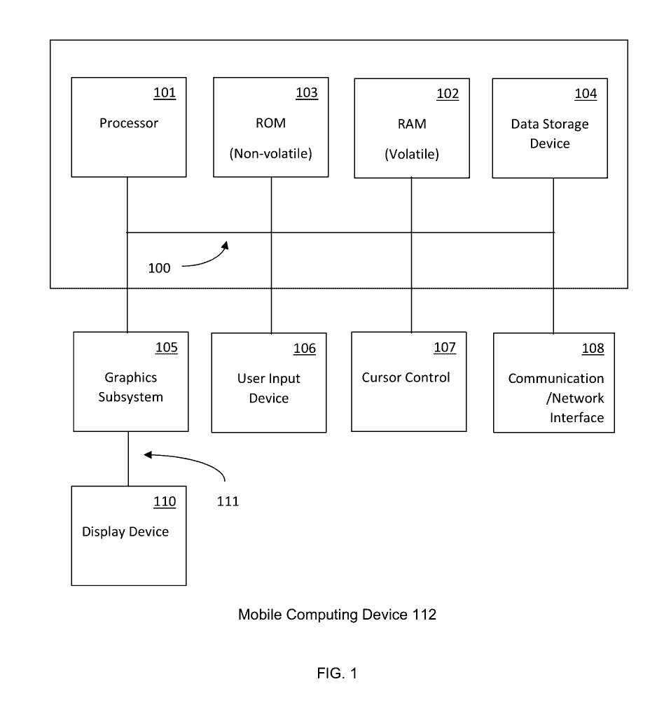

In the example of FIG. 1, the exemplary mobile computing device 112 includes a central processing unit (CPU) 101 for running software applications and optionally an operating system. Random access memory 102 and read-only memory 103 store applications and data for use by the CPU 101. Data storage device 104 provides non-volatile storage for applications and data and may include fixed disk drives, removable disk drives, flash memory devices, and CD-ROM, DVD-ROM or other optical storage devices. The optional user inputs 106 and 107 comprise devices that communicate inputs from one or more users to the mobile computing device 112 (e.g., mice, joysticks, cameras, touch screens, and/or microphones).

A communication or network interface 108 allows the mobile computing device 112 to communicate with other computer systems, networks, or devices via an electronic communications network, including wired and/or wireless communication and including an Intranet or the Internet. The touch sensitive display device 110 may be any device capable of displaying visual information in response to a signal from the mobile computing device 112 and may include a flat panel touch sensitive display. The components of the mobile computing device 112, including the CPU 101, memory 102/103, data storage 104, user input devices 106, and the touch sensitive display device 110, may be coupled via one or more data buses 100.

In the embodiment of FIG. 1, a graphics sub-system 105 may optionally be coupled with the data bus and the components of the mobile computing device 112. The graphics system may comprise a physical graphics processing unit (GPU) 105 and graphics memory. The GPU 105 generates pixel data from rendering commands to create output images. The physical GPU 105 can be configured as multiple virtual GPUs that may be used in parallel (e.g., concurrently) by a number of applications or processes executing in parallel.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### Automatic Absolute Orientation and Position Determination

The framework implemented herein detects known objects within the frame of a video feed. The video feed is received in real time from a camera connected to a mobile computing device such as a smartphone or tablet computer and may be stored in memory, and location coordinates (e.g., latitude and longitude or GPS-based coordinates) are associated with one or more known objects detected in the video feed. Based on the coordinates of the known objects, the user's absolute position and orientation is triangulated with a high degree of precision.

Object detection is performed using cascaded classifiers. A cascaded classifier describes an object as a visual set of items. According to some embodiments, the cascaded classifiers are based on Haar wavelet features of an image (e.g., a video frame). The output of the classifier may be noisy and produce a number of false-positive objects. Therefore, a set of heuristic procedures are performed to clean any noise in the object classifier's output. The heuristic procedures attempt to distinguish between objects that are accurately detected and false-positives from the object classifier. According to some embodiments, the image is converted to grayscale before object detection is performed.

Embodiments of the present invention select true objects from a potentially large group of candidates detected during object detection. Selecting true objects in the scene may be performed using three main steps.

In the first step, bounding boxes are placed around candidate objects for each frame and are grouped such that no two candidate objects are close together. In the second step, small areas around each of the candidate boxes are marked. Frames before and after the current frame (e.g., forward and backward in time) are searched within the marked boxes. The standard deviation of pixel values is computer over the pixels in each candidate bounding box. It is considered more likely that the bounding box contains an object if the standard deviation of pixel values is high. Candidate objects can be rejected quickly based on the size and/or dimensions of the detected object compared to the size and/or dimensions of known objects.

A final score is calculated for each candidate based on a weighted sum of the number of times the object appears in the frames just before and after the current frame and the standard deviation of the pixels from frame to frame. Typically, if a candidate object appears in multiple frames, it is more likely to represent a known object. If the final score calculated for an object is below a certain threshold, that object can be disregarded. This method has been observed to successfully detect objects in over 90% of the frames.

Prior to object detection, the system may be trained to detect objects using a large set of positive examples. The initial training process helps mitigate long detection times when the frames are processed for known objects. Object training uses a utility to mark locations of the objects in a large set of positive examples by hand. A large database of random images that do not represent the object may be provided to serve as negative examples. The training utility then automatically generates a data file (e.g., an XML file) that can be provided as a classifier to the framework. According to some embodiments, each object will have its own classifier because each object is assumed to be unique within the scene.

Auto-localization is performed based on the location of the known objects relative to the user. At least three non-collinear objects are detected in order to successfully triangulate the position of the user, and the three objects need not be detected simultaneously. For example, according to one embodiment, object locations with corresponding camera orientations and location coordinates may be cached and matched according to timestamps. Once the cache contains three valid corresponding objects, the location computation is automatically triggered and reported to the user application based on the cached data. It is therefore unnecessary to perform a manual location registration or to continuously poll for results.

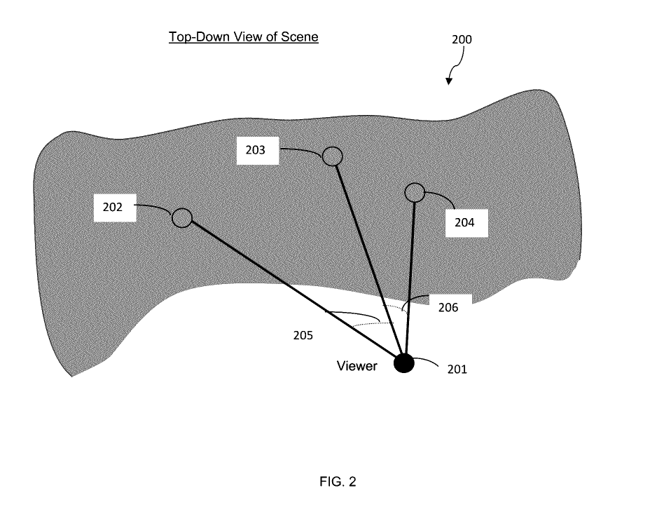

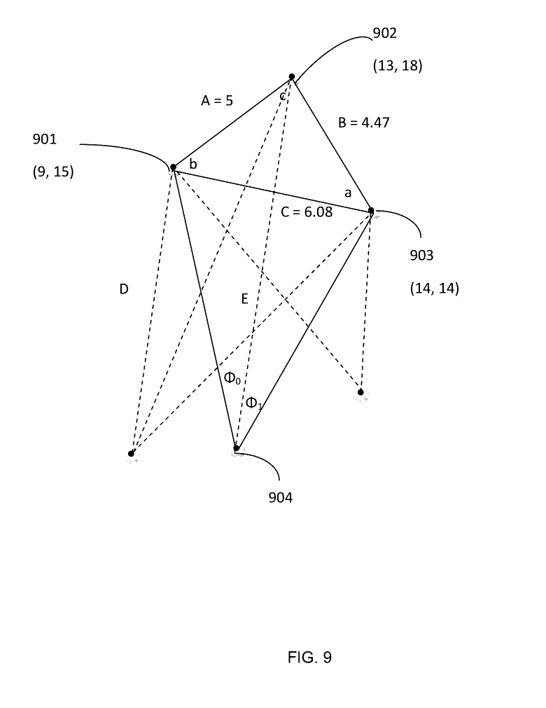

With regard to FIG. 2, a user at position 201 is in view of three objects with known locations (e.g., object 202, 203, and 204). The objects are non-collinear and in a triangular formation. The system determines angle 205 between objects 202 and 203, as well as angle 206 between objects 203 and 204, relative to the user's position 204. Because the system knows the locations of objects 202, 203 and 204, with each angle 205 and 206 determined, the system can triangulate the position 201 and orientation of the user with a high degree of precision (see FIG. 9).

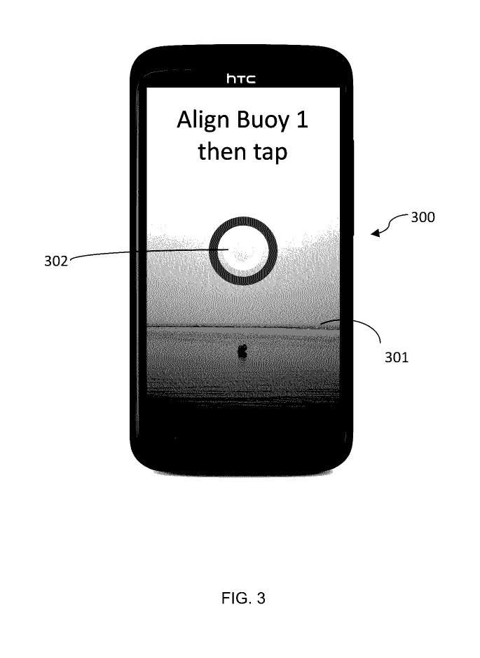

With regard to FIG. 3, exemplary mobile computing device 300 with touch sensitive screen 301 is depicted, according to some embodiments. The on-screen user interface depicted on touch sensitive screen 301 may be used to locate three objects of known locations. In the first step, the user is instructed to align target zone 302 with a first buoy, for example. According to some embodiments, once the first buoy is aligned in the target zone, the user may tap on the screen and the location of the object relative to the user is automatically determined and optionally cached.

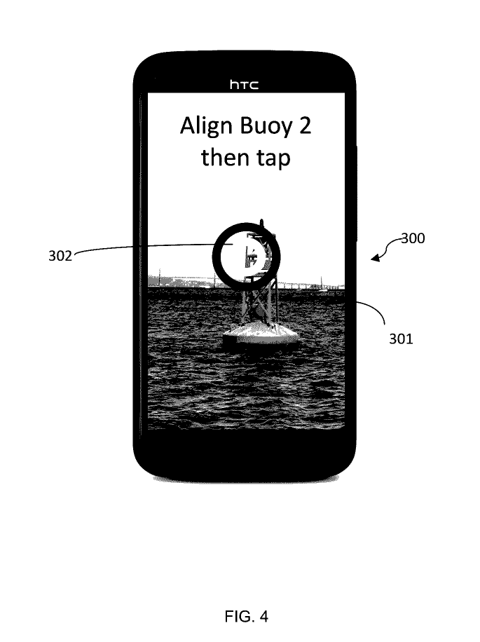

With regard to FIG. 4, exemplary mobile computing device 300 with touch sensitive screen 301 is depicted with on-screen UI, according to some embodiments. In the second step, the user is instructed to align target zone 302 with a second buoy, for example. According to some embodiments, once the second buoy is aligned in the target zone, the user simply taps on the screen and the location of the object relative to the user is determined and optionally cached.

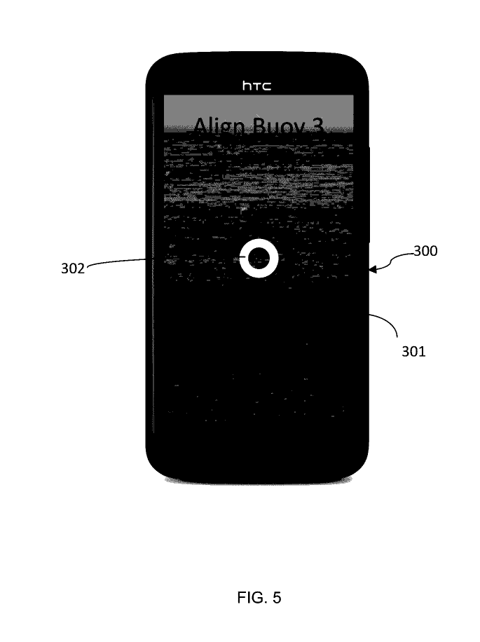

With regard to FIG. 5, exemplary mobile computing device 300 with touch sensitive screen 301 is depicted with on-screen UI, according to some embodiments. This interface is used to locate three objects of known locations. In the third step, the user is instructed to align target zone 302 with a third buoy, for example. According to some embodiments, once the third buoy is aligned in the target zone, the user simply taps on the screen and the location of the object relative to the user is determined and optionally cached.

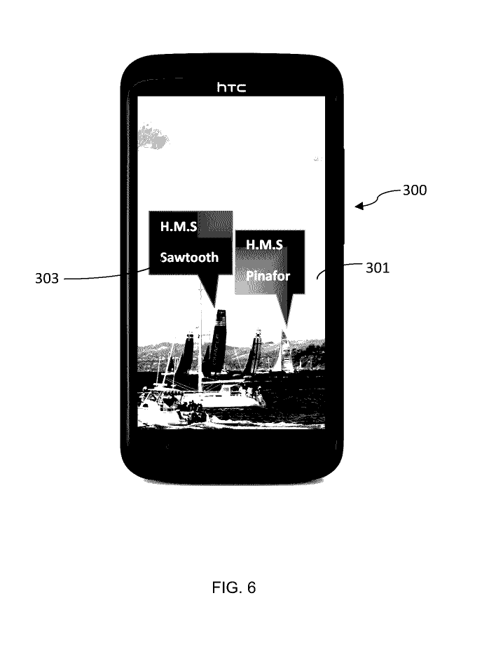

With regard to FIG. 6, exemplary mobile computing device 300 with touch sensitive screen 301 is depicted with an on-screen UI, according to some embodiments. After three objects with known locations have been identified and aligned by the user, the system can determine and track the user's absolute orientation and position. With this data, the system can accurately display the content of augmented reality overlay 303 on touch sensitive screen 301 in real-time. For example, augmented reality overlay 303 may display the names of objects detected in the scene, such as the H.M.S. Sawtooth and the H.M.S. Pinafor, for example. At a later time, it may be determined that the user device has changed orientation and/or position, or that a known object in the scene has changed position. In this case, the content and/or position of augmented reality overlay 303 will be updated based on the determined change in orientation and/or position. For example, if it is determined that the H.M.S. Sawtooth has changed positions, augmented reality overlay 303 will adjust to the new position.

With regard to FIG. 7, a flowchart 700 of an exemplary computer implemented method for automatically detecting known objects in a video stream is depicted. At step 701, a first candidate object is detected using cascaded classifiers. At step 702, a bounding box is placed around the first candidate object in each of a first frame, a second frame, and a third frame of the video feed. An area immediately surrounding the bounding box in each frame is marked at step 703. A standard deviation of pixel values for a plurality pixels in the area that has been marked in each frame is computed at step 704, and a final score for the candidate object based on the standard deviation is computed at step 705.

With regard to FIG. 8, a flowchart 800 of an exemplary computer implemented method for determining absolute orientation and position is depicted. At step 801, a live video feed is received on a mobile computing device. At step 802, a first, second, and third object are detected in one or more frames of the live video feed. An absolute position and orientation of the mobile computing device is determined based on a set of location coordinates associated with the first, second, and third objects at step 803.

Given three points of a triangle with known absolute latitudes and longitudes, it is possible to determine the absolute position and orientation of a fourth point located outside of the triangle if the angles of the points relative to the fourth point are known using trigonometry. Therefore, using these techniques, the location of three known objects and the angle between the objects may be used to derive an absolute position and orientation of the user device. These techniques may offer greater accuracy when compared to GPS position data in consumer devices which typically provides accuracy to only 6-8 meters. With respect to the exemplary calculation illustrated in FIG. 9, the techniques for deriving the absolute orientation and position of a fourth point, given three points of known position that form a triangle, include the following calculations:

$$sin ( a + b ) = sin ( a ) cos ( b ) + sin ( b ) cos ( a ) \\ {⊖}_{0} = Π - ( b + Π + {e}_{0} + {φ}_{0} ) = Π - b - Π {e}_{0 -} {φ}_{0} \\ {⊖}_{0} = - b - {e}_{0} - φ0$$

$$\frac{D}{sin ( {θ}_{0} )} = \frac{A}{sin {φ}_{0}}$$

$$D = \frac{A sin ( {θ}_{0} )}{sin ( {φ}_{0} )}$$

$$\frac{A}{sin ( {φ}_{0} )} = \frac{E}{sin ( {e}_{0} + b )}$$

$$\frac{B}{sin ( {φ}_{1} )} = \frac{E}{sin ( {e}_{1} + a )} = \frac{E}{sin ( z - {e}_{0} + a )}$$

$$E = \frac{B sin ( z - {e}_{0} + a )}{sin ( {φ}_{1} )}$$

$$E = \frac{A sin ( {e}_{0} + b )}{sin ( {φ}_{0} )}$$

$$\frac{A sin ( {e}_{0} + b )}{sin ( {φ}_{0} )} = \frac{B sin ( z - {e}_{0} + a )}{sin ( {φ}_{1} )}$$

$$\frac{sin ( {φ}_{1} )}{sin ( {φ}_{0} )} \frac{A}{B} ( sin ( {e}_{0} ) cos ( B ) + sin ( B ) cos ( {e}_{0} ) ) = sin ( z + a ) cos ( {e}_{0} ) - sin ( {e}_{0} ) cos ( z + a )$$

$$\frac{A sin ( {φ}_{1} )}{B sin ( {φ}_{0} )} = Y$$

$$Y sin ( {e}_{0} ) cos ( b ) + Y sin ( b ) cos ( {e}_{0} ) - sin ( z + a ) cos ( {e}_{0} ) + sin ( {e}_{0} ) cos ( z + a ) = 0$$

$$Y sin ( {e}_{0} ) cos ( b ) + sin ( {e}_{0} ) cos ( z + a ) + Y sin ( b ) cos ( {e}_{0} ) - sin ( z + a ) cos ( {e}_{0} ) = 0$$

$$sin ( {e}_{0} ) ( Y cos ( b ) + cos ( z + a ) ) + cos ( {e}_{0} ) ( Y sin ( b ) - sin ( z + a ) ) = 0$$

$$sin ( {e}_{0} ) ( Y cos ( b ) + cos ( z + a ) ) = - cos ( {e}_{0} ) ( Y sin ( b ) - sin ( z + a ) )$$

$$sin ( {e}_{0} ) ( Y cos ( b ) + cos ( z + a ) ) / cos ( {e}_{0} ) = - ( y sin ( b ) - sin ( z + a ) )$$

$$\frac{sin ( {e}_{0} )}{cos ( {e}_{0} )} = \frac{- ( Y sin ( b ) - sin ( z + a )}{Y cos ( b ) + cos ( z + a )}$$

$$\frac{sin ( {e}_{0} )}{cos ( {e}_{0} )} = \frac{sin ( z + a ) - Y sin ( b )}{Y cos ( b ) + cos ( z + a )}$$

$${e}_{0} = {tan}^{- 1} \frac{sin ( z + a ) - Y sin ( b )}{Y cos ( b ) + cos ( z + a )}$$

With respect to the exemplary object locations of FIG. 9 (e.g., point 901, 902, and 903) and unknown position 904, it is determined that φ₀=11.25° and φ₁=11.25°, a=66.5, b=40.43, and θ=73.0724.

$$Where {e}_{0} = {tan}^{- 1} - \frac{Y sin ( b ) - sin ( a + z )}{Y cos ( b ) + cos ( z + a )}$$

$$\frac{E}{sin ( b + {e}_{0} )} = \frac{A}{sin ( {θ}_{0} )}$$

$$E = A sin ( b + {e}_{0} ) / sin ( {φ}_{0} ) = - 18.0237$$

Embodiments of the present invention are thus described. While the present invention has been described in particular embodiments, it should be appreciated that the present invention should not be construed as limited by such embodiments, but rather construed according to the following claims.

1. A method of determining absolute position and orientation of a mobile computing device, comprising:
capturing a live video feed on the mobile computing device;
detecting first, second, and third objects in one or more frames of the live video feed, wherein the first object is associated with a first set of location coordinates, the second object is associated with a second set of location coordinates, and the third object is associated with a third set of location coordinates and is non-collinear with the first and second objects; and
determining said absolute position and orientation of the mobile computing device based on the set of location coordinates associated with the first, second, and third objects; and
displaying an augmented reality overlay on a display screen of the mobile computing device, wherein one of a content and a position of the augmented reality overlay is based on the absolute position and orientation of the mobile computing device, and wherein said determining comprises:
determining an angle between the first object and the second object relative to a position of the mobile computing device; and
determining an angle between the second object and the third object relative to a position of the mobile computing device.

2. The method of claim 1, further comprising caching the first set of location coordinates upon detection of the first object and caching the second set of location coordinates upon detection of the second object.

3. The method of claim 2, further comprising caching a timestamp when the first, second, and/or third object is/are detected.

4. (canceled)

5. The method of claim 1, wherein said detecting comprises aligning the first, second, and/or third object with a target zone displayed on a screen of the mobile computing device.

6. The method of claim 1, further comprising displaying location-specific information on a screen of the mobile computing device based on the absolute position and orientation.

7. The method of claim 1, further comprising determining the first, second, and third set of location coordinates using a database of known objects and associated location coordinates.

8. The method of claim 7, wherein said locating the objects comprises using cascaded classifiers to match each object of said first, second, and third objects with a known object in the database of known objects and associated location coordinates.

9. The method of claim 8, wherein said cascaded classifiers are based on Haar wavelet features of grayscale versions of the frames.

10. The method of claim 1, wherein said one of said content and said position of the augmented reality overlay is further based on a location of a detected object and further comprising:
detecting a change in the absolute position and/or orientation of the mobile computing device and/or the location of the detected object; and
updating a content and/or position of the augmented reality overlay on the screen of the mobile computing device based on the change.

11. A computer usable medium having computer-readable program code embodied therein for causing a computer system to execute a method of determining an absolute position and orientation of a mobile computing device, wherein the method comprises:
capturing a live video feed on the mobile computing device;
detecting first, second, and third objects in one or more frames of the live video feed, wherein the first object is associated with a first set of location coordinates, the second object is associated with a second set of location coordinates, and the third object is associated with a third set of location coordinates and is non-collinear with the first and second objects;
determining the absolute position and orientation of the mobile computing device based on the set of location coordinates associated with the first, second, and third objects; and
displaying an augmented reality overlay on a display screen of the mobile computing device, wherein one of a content and a position of the augmented reality overlay is based on the absolute position and orientation of the mobile computing device, and wherein said determining comprises:
determining an angle between the first object and the second object relative to a position of the mobile computing device; and
determining an angle between the second object and the third object relative to a position of the mobile computing device.

12. The computer usable medium of claim 11, wherein said method further comprises caching the first set of location coordinates upon detection of the first object and caching the second set of location coordinates upon detection of the second object.

13. The computer usable medium of claim 12, wherein said method further comprises caching a timestamp when the first, second, and/or third object is detected.

14. (canceled)

15. The computer usable medium of claim 11, wherein said detecting comprises aligning the first, second, and/or third object with a target zone displayed on a screen of the mobile computing device.

16. The computer usable medium of claim 11, wherein said method comprises displaying location-specific information on a screen of the mobile computing device based on the absolute position and orientation.

17. The computer usable medium of claim 11, wherein the method further comprises determining the location coordinates associated with the first, second, and third objects by locating the objects in a database of known objects and associated location coordinates.

18. The computer usable medium of claim 17, wherein said locating the objects comprises using cascaded classifiers to match each object of the first, second, and third objects with the known object in a database of known objects.

19. The computer usable medium of claim 18, wherein said cascaded classifiers are based on Haar wavelet features of grayscale versions of the frames.

20. A mobile computing device comprising:
a display screen;
a general purpose processor;
a system memory; and
a camera system configured to capture a live video feed coupled to a data bus used to transfer the video feed to the system memory, wherein the general purpose processor is configured to:
analyze the live video feed to locate first, second, and third objects in one or more frames of the live video feed, wherein the first object is associated with a first set of location coordinates, the second object is associated with a second set of location coordinates, the third object is associated with a third set of location coordinates and is non-collinear with the first and second objects,
compute an absolute position and orientation of the mobile computing device based on the set of location coordinates associated with the first, second, and third objects, and
display an augmented reality overlay on the display screen, wherein one of a content and a position of the augmented reality overlay is based on the absolute position and orientation of the mobile computing device, and wherein said compute comprises:
computing an angle between the first object and the second object relative to a position of the mobile computing device; and
computing an angle between the second object and the third object relative to a position of the mobile computing device.
